(19) United States
(12) Patent Application Publication
(10) Pub. No.: US 2007/0122135 A1
(43) Pub. Date: May 31, 2007

(54) Kit for remote control of the shutter release of photographic equipment and the like and orientatable head designed for mounting said kit

(76) Inventor: Paolo Speggiorin, Mussolente (IT)

Correspondence Address: RATNERPRESTIA, P O BOX 980, VALLEY FORGE, PA, 19482-0980, US

(21) Appl. No.: 10/584,030

(22) PCT Filed: Nov. 3, 2004
(86) PCT No.: PCT/EP04/12414

§ 371 Date: Aug. 14, 2006

(30) Foreign Application Priority Data
Jan. 8, 2004 (IT) PD2004A000002

(51) Int. Cl. G03B 17/00

(52) U.S. Cl. 396/56

(57) ABSTRACT

A kit for remote control of the shutter release of photographic equipment and the like including a remote control device preferably of the electrical or electronic type having a release switch and a mount for the device to support the same on a photographic head or other equipment. A seat to house the control device is provided on the mount and the device is removably housed within the seat.

This Application is a U.S. National Phase Application of PCT International Application PCT/EP2004/012414.

### TECHNICAL FIELD OF THE INVENTION

This invention relates to a kit for remote control of the shutter release of photographic equipment and the like and an orientatable head designed for mounting the said kit.

### BACKGROUND ART

In photography there is a need for remote control of the shutter release of photographic equipment so that the latter can be remotely operated.

Sheathed metal wire controls (e.g. Bowden cables) are typically used for this purpose, or in the case of more recent equipment, controls of the electric or electronic type. The former act on the photographic equipment as mechanical relays between the shutter release on the equipment and a remote plunger action; the latter perform the same functions through electrical signals transmitted through conductors.

In every case it is typical that the release plunger has no links with the orientatable head which supports the photographic equipment or is rigidly secured thereto.

In the former situation the device having the shutter release of the electric or electronic type is potentially exposed to damage when the equipment and the head on which it is mounted are handled; in the latter situation the device is rather unsuitable or wholly unsuitable for removal from the head for any contingent need.

Furthermore, because the head and the device form a single whole, the two parts cannot be marketed separately, thus penalizing the selling price of the head in the case of purchasers who do not require remote control of the shutter release. In neither case is it possible to move the device by adjusting its position to different orientations of the head.

### BRIEF SUMMARY OF THE INVENTION

The main object of the invention is to provide a kit which makes it possible to overcome all the disadvantages mentioned with reference to the cited prior art.

A further object of the invention is to help protect the remote control device when it is not in use.

Yet another object of the invention is that of providing a kit and a head or other support for aiming the photographic equipment supported thereon which is sufficiently versatile to permit different relative mutual positions in such a way that it is possible to take photographs without releasing the handle of the aiming support.

These objects, and yet others which will be apparent below, are accomplished by the invention through a kit for remote control of the shutter release of photographic equipment and the like and an orientatable head designed for mounting the kit. The kit includes a remote control device having a release switch and a mount for mounting the remote control device to support the same on a photographic head. And a seat is provided to receive the remote control device in the mount and the remote control device is removably housed in the seat.

### BRIEF DESCRIPTION OF THE DRAWINGS

The features and advantages of the invention will be more apparent from the detailed description of a preferred but not exclusive embodiment below illustrated indicatively and non-restrictively with reference to the appended drawings in which:

FIG. 1 is a frontal perspective view of a kit according to the invention,

FIG. 2 is a rear perspective view of the control device of the kit in FIG. 1,

FIG. 3 is an elevation view of a head for photographic equipment equipped with the kit in FIG. 1,

FIG. 4 is a perspective view of a component of the kit in a variant embodiment,

FIGS. 5 to 8 show different positions of a photographic head with an aiming handle and corresponding positions of the kit according to this invention.

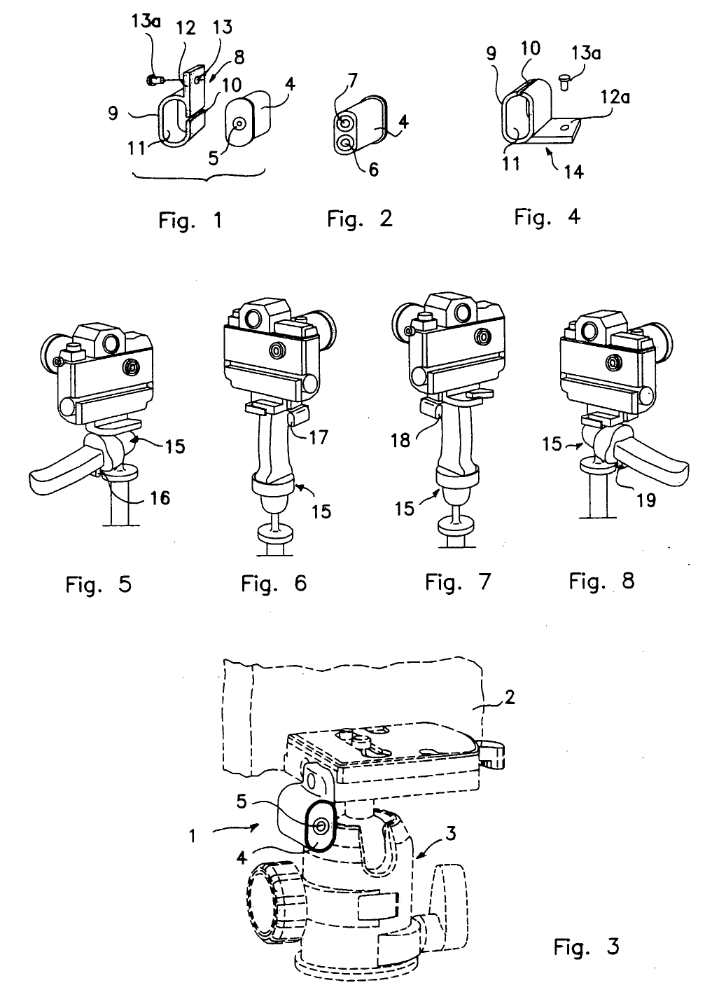

### DETAILED DESCRIPTION OF THE INVENTION

In the figures, 1 indicates as a whole a kit for remote control of the shutter release of an item of photographic equipment 2 mounted on an orientatable head 3.

Kit 1 comprises a remote control device 4 of the electrical type having an elongated body which carries respectively on its two axially opposing sides a release switch 5 and a jack-type socket 6, 7 for a cable which is in itself known for connection to photographic equipment 2 in order to control its shutter release through switch 5. Kit 1 also comprises a mount 8 for mounting the said device in order to support the same on head 3 or other equipment. Mount 8 has an annular sheath-like strip 9 which is not completely closed on itself in order to form a gap 10 which extends axially. Gap 10 renders strip 9 resiliently partable.

Strip 9 forms a seat 11 in which control device 4 is removably housed in a substantially complete manner, or with only the release switch and the corresponding surrounding part projecting from the strip. When inserted in seat 11 device 4 brings about elastic extension of strip 9 so that it remains firmly held in seat 11.

Mount 8 also comprises an appendage 12 extending outside seat 11 and having a hole 13 and/or other suitable fixing means to secure the mount to head 3 through a fixing screw 13a.

Preferably kit 1 comprises a second mount 14 which differs from the above only in the position of appendage 12a with respect to strip 9. Similar details of mounts 8 and 14, excepting those indicated above, are identified by the same numbers.

Kit 1 is particularly suitable for fitting to a head 15 of the type with a pistol-grip aiming handle, as illustrated in FIGS. 5 to 8, which is provided for this purpose with a plurality of alternative operating positions in which kit 1 can be alternatively fixed.

Corresponding first, second, third and fourth attachment means 16, 17, 18 and 19, each including a flat portion against which appendage 12 pierced by a threaded hole for screw 13a abuts, may be placed in these positions.

In these operating positions mount 8 can therefore be alternatively fixed with appendage 12 abutting against the flat portion to receive the shutter release remote control device in the position most appropriate for the different positions of the head.

Kit 1 can however also be used with different heads as indicated in FIG. 3.

The invention thus fulfills the objects stated, offering many advantages with respect to what has hitherto been known. Of these the following are particularly valuable. In the first place the kit can be marketed separately from the head, thus forming a supplementary accessory. In the second place it can be positioned at will in different operating positions which with the handle in FIGS. 5 to 8 makes it possible to take photographs without releasing the handle of the opening support. In addition to this the remote control device is well protected in all circumstances.

1. Kit for remote control of the shutter release of photographic equipment and the like comprising a remote control device having a release switch and a mount for mounting the remote control device in order to support the same on a photographic head or other equipment, wherein a seat to receive the remote control device is provided in the mount and the remote control device is removably housed in the seat.

2. The kit according to claim 1 in which the mount comprises an incompletely closed annular strip defining the seat.

3. The kit according to claim 1 in which the remote control device comprises an elongated body which is capable of being completely housed in the seat.

4. The kit according to claim 2, in which the mount comprises an appendage extending from the annular strip outside the seat and fixing means on the appendage to secure the mount to the photographic head.

5. The kit according to claim 4 in which the removable fixing means comprise at least one hole on the appendage.

6. The kit according to claim 4, comprising at least two mounts which differ from each other in the relative position between the annular strip and the appendage.

7. An orientatable head including a kit according to claim 1 in which the mount is removably securable to the photographic head in a plurality of alternative operating positions.

8. The kit according to claim 2 in which the remote control device comprises an elongated body which is capable of being completely housed in the seat.

9. The kit according to claim 3, in which the mount comprises an appendage extending from the annular strip outside the seat and fixing means on the appendage to secure the mount to the photographic head.

10. The kit according to claim 5, comprising at least two mounts which differ from each other in the relative position between the annular strip and the appendage.

11. The kit according to claim 1, wherein the remote control device is of the electrical or electronic type.
